(19) United States
(12) Patent Application Publication
(10) Pub. No.: US 2006/0012577 A1
(43) Pub. Date: Jan. 19, 2006

(54) Active keypad lock for devices equipped with touch screen

(75) Inventor: Marko Kyrola, Kangasala (FI)

Correspondence Address: WARE FRESSOLA VAN DER SLUYS &;ADOLPHSON, LLP, BRADFORD GREEN BUILDING 5, 755 MAIN STREET, P O BOX 224, MONROE, CT, 06468, US

(73) Assignee: Nokia Corporation

(21) Appl. No.: 10/893,566

(22) Filed: Jul. 16, 2004

(51) Int. Cl. G09G 5/00

(52) U.S. Cl. 345/173

(57) ABSTRACT

A device comprising at least a touch screen and a keypad for providing input functions. The keypad is provided with a key lock operation comprising an active state and a inactive state. The active state is adapted to disable at least part of the input functions of the keypad, and the inactive state is adapted to enable the input functions of the keypad. The device also comprises a detector for detecting when a stylus is in proximity with the touch screen; and a key lock activator for setting the key lock into said active state when the detector provides indication of the proximity of the stylus.

### FIELD OF THE INVENTION

The present invention relates to a device comprising at least a touch screen and a keypad. The invention also relates to a system comprising a touch screen and a keypad. The invention further relates to a method and a computer program product to be used in processing input information from a touch screen and a keypad.

### BACKGROUND OF THE INVENTION

There exist devices comprising a touch screen, which can be used in connection with a display to provide input information to the devices, for example to perform selections among objects shown on the display. Such devices may also comprise a keypad for inputting information by the keys of the keypad. For example, the user of the device may input a text message or a telephone number by the keypad.

There are some different kind of touch screens available. For example, there are inductive touch screens in which an inductive stylus is used to perform the touch operation. When the inductive stylus approaches the touch screen the detection circuitry detects the stylus, determines the touching point of the stylus and provides e.g. coordinate information on the touching point. The coordinate information of the touching point can then be used to determine which operation relates to the touching point.

There are also optical, acoustical, resistive and capacitive touch screens, for example. These kind of touch screens do not usually need a special stylus to be used but, for example, a finger can normally be used as the stylus.

There exists a problem with usability in devices equipped both with a touch screen and a keypad. It may happen that when the user tries to touch the touch screen to perform some touch based action either with finger or stylus he or she simultaneously presses some key or keys in the keypad. This may effect initiation of an unintentional action.

There are some ways to avoid this usability problem for example by ensuring that the device size is big enough, by placing the touch screen and keys of the keypad not close to each other, therefore decreasing the probability to press the keys unintentionally. Another solution to avoid the aforementioned problem is to use a longer stylus, which can, however, make the pointing more difficult.

The so called key lock operation is known by which the keypad of a device can be disabled and enabled. The key lock can be activated and deactivated by pressing a certain key or a key combination of the keypad. This may be cumbersome because every time the user wants to use the touch screen he or she should manually activate the key lock if it is not active and if the user wants the key lock to be activated, for example, to avoid erroneous key presses.

The European patent application EP 1 284 450 discloses a method for preventing unintended touch pad input due to accidental touching. In the method the similar key lock operation can be activated to disable at least some of the touch screen functions. The key lock is activated and deactivated by a certain key or by a certain key combination wherein by pressing the certain key or key combination the status of the key lock is changed i.e. the key lock is activated or deactivated. However, the key lock does not effect the operation of the key pad itself wherein if the user wants to lock the keypad he or she has to do it manually by pressing a certain key or key combination on the keypad.

### SUMMARY OF THE INVENTION

In the present invention there is provided a solution for reducing the effects of unintentional touching of a keypad when operating the touch screen. The invention is based on the idea that the key lock of the keypad can be activated while beginning the operation of the touch screen. The activation may be based on detecting when the stylus of the touch screen is in proximity of the touch screen or detecting when the stylus such as a finger touches the touch screen or any other operation that is related to the touch screen operation. The status of the key lock of the keypad may be indicated on the screen. The feature can be switched off, because some features or actions of the device may require simultaneous use of the keypad and the touch screen.

According to a first aspect of the present invention there is provided a device comprising at least
a touch screen;
a keypad for providing input functions, the keypad being provided with a key lock operation comprising an active state and a inactive state, the active state being adapted to disable at least part of the input functions of the keypad, and the inactive state being adapted to enable the input functions of the keypad;
a detector for detecting when a stylus is in proximity with the touch screen; and
a key lock activator for setting the key lock into said active state when the detector provides indication of the proximity of the stylus.

According to a second aspect of the present invention there is provided a system comprising at least
a touch screen;
a keypad for providing input functions, the keypad being provided with a key lock operation comprising an active state and a inactive state, the active state being adapted to disable at least part of the input functions of the keypad, and the inactive state being adapted to enable the input functions of the keypad;
a detector for detecting when a stylus is in proximity with the touch screen; and
a key lock activator for setting the key lock into said active state when the detector provides indication of the proximity of the stylus.

According to a third aspect of the present invention there is provided a method comprising at least
activating a key lock of a keypad, the keypad being provided with a key lock operation comprising an active state and a inactive state, in which active state at least part of input functions of the keypad being disabled, and in which inactive state the input functions of the keypad being enabled;
detecting when a stylus is in proximity with the touch screen; and
setting the key lock into said active state when the proximity of the stylus is detected.

According to a fourth aspect of the present invention there is provided a computer program product comprising machine executable steps for
activating a key lock of a keypad, the keypad being provided with a key lock operation comprising an active state and a inactive state, in which active state at least part of input functions of the keypad being disabled, and in which inactive state the input functions of the keypad being enabled;
detecting when a stylus is in proximity with the touch screen; and
setting the key lock into said active state when the proximity of the stylus is detected.

The invention improves the usability of small electronic devices and reduces the effects of unintentional actions for example when the user, while touching the touch panel, unintentionally presses one or more keys of the keypad of the device.

### DESCRIPTION OF THE DRAWINGS

In the following the present invention will be described in more detail with reference to the appended drawings in which

FIG. 1 depicts a device according to an example embodiment of the present invention as a simplified block diagram,

FIG. 2 depicts an example of a user interface of a device according to an example embodiment of the present invention,

FIG. 3 shows as a flow diagram the method according to an example embodiment of the present invention, and

FIG. 4 depicts another example of a user interface of a device according to an example embodiment of the present invention.

### DETAILED DESCRIPTION OF THE INVENTION

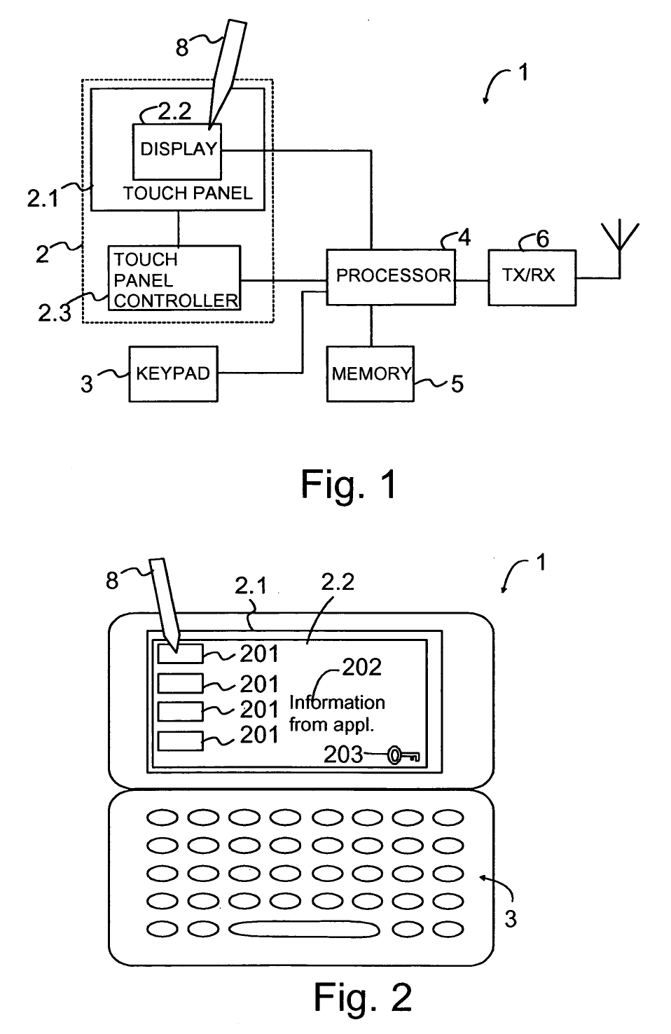

An example of a device 1 and a system according to the present invention is shown in FIG. 1. The device 1 is, for example, a portable device such as a communicator, a personal digital assistant (PDA), a smart phone etc. but the invention is not solely restricted to these kinds of devices. The device 1 comprises a touch screen 2 which includes a touch panel 2.1, a display 2.2 (also known as a screen), and a touch panel controller 2.3. The touch pointing is handled with stylus 8 or with a finger. The device 1 also comprises a keypad 3, a processor 4 and a memory 5. The device 1 may also comprise a transmitter/receiver 6 for communicating with other devices (not shown) directly and/or via a network (not shown). It should be noted here that the device 1 may comprise more than one processor, display, keypad, memory, transmitter/receiver, etc.

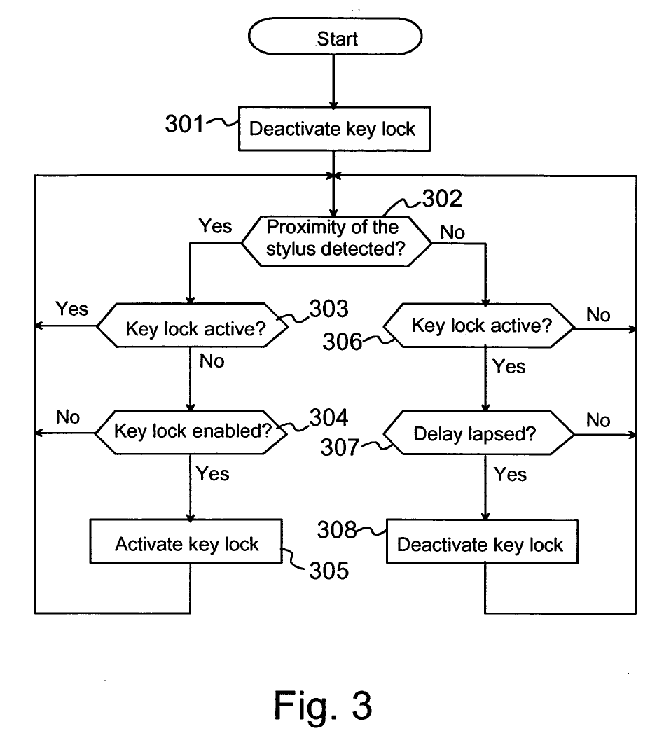

In the following the operation of an example method of the present invention will be described in connection with the device 1 of FIG. 1. The reference is also made to the flow diagram of FIG. 3 showing some of the steps of the method according to an example embodiment of the present invention. When the device 1 is powered up, the touch panel controller 2.3 initializes the touch panel 2.1. The touch panel 2.1 may need a calibration to calibrate the touch panel 2.1 with the display 2.2. The processor 4 can also perform initialization operations to the device 1, for example, to set the status of the key lock (block 301 in FIG. 3), send information on the display 2.2, perform a registration process to a wireless network by the transmitter/receiver 6, etc. After the initialization is completed some information can be shown on the display and the user can begin to use the device 1. It is assumed here that the key lock of the keypad 3 is deactivated in the beginning of the operation of the device 1 but it may also be activated.

The touch panel controller 2.3 checks 302 at intervals or based on interrupts the status of the touch panel to determine whether the touch panel 2.1 is touched by a stylus 8 (FIG. 2) or not. The way the touch can be detected depends on the type of the touch panel 2.1. In addition to the touch detection some touch panels 2.1 can also detect when the stylus is in proximity of the touch panel 2.1. For example, by inductive touch panels it may be possible to detect an inductive stylus even when the stylus is approximately several centimeters away from the surface of the touch panel 2.1. This proximity detection can be used as an indication that the stylus is approaching the touch panel 2.1.

When the touch panel controller 2.3 detects that the stylus 8 touches the touch panel 2.1 the touch panel controller 2.3 sends information on the touch to the processor 4. The information may include coordinates of the touch or other information of the location of the touch on the touch panel 2.1. The processor 4 determines that there is a touch on the touch screen wherein the key lock of the keypad 3 should be activated unless the activation of the key lock is prevented, for example, by the user. The processor 4 may examine 303 before activating the key lock whether the key lock is already active, wherein it is not necessary to change the status of the key lock. The status of the key lock is stored in the memory 5 for a later use. The status of the key lock may also be indicated on the display 2.2 for example by a symbol 203 (FIG. 2) or by some text. It is also possible that the status of the key lock is only indicated when the key lock is either active or inactive. The other status of the key lock can then be determined by the absence of the indication 203.

In an example embodiment of the present invention it is possible to prevent the activation of the key lock. Therefore, a key lock enablement indicator is provided e.g. in the memory 5. The processor 4 examines 304 the value of the key lock enablement indicator to determine whether the key lock can be activated or not. If it is determined that the key lock can be activated, the processor 4 sets 305 the key lock active.

The processor 4 also examines, when necessary, the location information received from the touch panel controller 2.3 and compares it with the information shown on the display 2.2. There may be activation areas 201 (FIG. 2) shown on the display 2.2 to activate the function connected with the activation area. When the processor 4 detects that the coordinates of the touch are within an activation area 201 the processor 4 examines which function is connected with that activation area and begins the processing of the function. The function can be, for example, setting up a call, receive a call, execution of an application etc. It is also possible that some of the activation areas are meant for inputting free-form information such as drawing a picture, handwriting a note etc.

The touch panel controller 2.3 can continuously provide information of the touch when the stylus is pressed on the touch panel 2.1 or is in proximity with the touch panel 2.1. The coordinate information of the touch can be updated when the location of the touch changes.

In an example embodiment of the present invention the key lock is activated all the time the touch is detected. When the touch panel controller 2.3 detects that the stylus is not touching the touch panel 2.1 any more or is diverged from the proximity of the touch panel 2.1 the touch panel controller 2.3 may provide an indication of the end of the touch to the processor 4, or the touch panel controller 2.3 stops transmitting coordinate information to the processor 4. In the first alternative, the processor 4 detects the indication of the end of the touch and can use this information to update the status of the key lock. In the latter alternative a delay has been defined for the processor 4 wherein if the key lock is active 306 and no coordinate information is received from the touch panel controller 2.3 during the delay the processor 4 deduces 307 that the stylus is not touching the touch panel anymore. When the processor 4 has detected the end of the touch the key lock of the key pad 3 may be deactivated 308. However, if the user of the device 1 has manually activated the key pad for example by pressing certain keys of the keypad 3 the deactivation of the key lock by the processor 4 may have been prevented. In such a situation the user may not want that the processor 4 deactivates the key lock but the user may wish to manually deactivate the key lock at a later stage.

When the touch panel controller 2.3 can detect the proximity of the stylus before the stylus is in contact with the touch panel 2.1 the proximity detection can be used by the processor 4 to activate the key lock of the keypad 3. Therefore, the processor 4 need not wait for the coordinate information thus allowing the activation of the key lock at an earlier stage compared with the above described embodiment.

FIG. 2 shows an example of a user interface of the device 1. The user interface comprises the touch screen 2 and the keypad 3. On the display 2.2 some information can be depicted to the user. For example, activation areas 201 and information 202 relating to an application being executed in the device 1 can be shown on the display 2.2.

It should be noted here that there can be some alternatives on the styluses 8 which can be used with the touch screen 2. Some touch screens require a certain kind of stylus (e.g. the inductive touch screen) while other kind of touch screens may function properly with many different kinds of styluses. Further, the term “touch” need not necessarily mean that the stylus really touches the surface of the touch panel 2.1 but the touch may also be detected when the stylus is close to the surface but not touching it. For example, in some embodiments the touch can be detected when the stylus is from few millimeters to several centimeters above the surface of the touch panel 2.1. There may also be a protective and at least partly transparent cover (not shown) on the surface of the touch panel 2.1 wherein the stylus 8 touches the cover but not the touch panel 2.1.

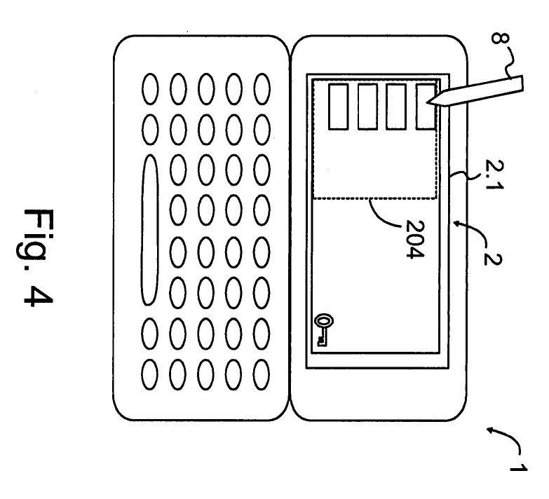

In another example embodiment of the present invention a certain detection area 204 is defined on the touch screen 2 for the detection of the proximity of the stylus 8. An example of a user interface in which such detection area 204 is defined is depicted in FIG. 4. The proximity of the stylus 8 is to be detected when the stylus 8 is in proximity with the detection area 204 of the touch screen 2 and the key lock can be activated on the basis of the detection. If the stylus 8 is in proximity of the touch screen 2 but outside of the detection area 204 the proximity indication is not provided or, if the proximity indication is provided, it is not used to indicate the proximity of the stylus 8. This kind of implementation can be used, for example, to restrict the area of the touch screen 2 on which the stylus 8 can be used for performing touch based operations. The detection area 204 can be defined in several different ways. For example, the detection area 204 can be predefined in the device 1, or the detection area 204 can be defined by an application running in the device 1, by a user of the device 1, or by an operating system of the device 1, etc. In these example embodiments of the invention the detection area 204 is not necessarily defined on a fixed part of the touch screen 2 but the location of the detection area 204 can vary in different situations. For example, if the detection area 204 is defined by an application which produces different kinds of outlooks on the display 2.1, the location of the detection area 204 may vary according to the outlook produced by the application. This kind of approach is useful inter alia when different outlooks comprise different kinds of selectable objects presented to the user on the display 2.1 and the location of the selectable objects may be different in different outlooks.

The present invention is not solely limited to the above described embodiments but it can be varied within the scope of the appended claims.

1. A device comprising at least
a touch screen;
a keypad for providing input functions, the keypad being provided with a key lock operation comprising an active state and a inactive state, the active state being adapted to disable at least part of the input functions of the keypad, and the inactive state being adapted to enable the input functions of the keypad;
a detector for detecting when a stylus is in proximity with the touch screen; and
a key lock activator for setting the key lock into said active state when the detector provides indication of the proximity of the stylus.

2. The device according to claim 1, the touch screen comprising a touch panel, a touch panel controller, and a display; the touch panel controller being adapted to operate as said detector and to provide said indication when the stylus is in proximity with the touch panel.

3. The device according to claim 2, the touch panel controller being adapted to provide said indication when the stylus touches the touch panel.

4. The device according to claim 3, said touch panel controller being adapted to provide indication of coordinate information of the touching point of the stylus on the touch panel, wherein said key lock activator is adapted to use the provided coordinate information as said indication of the proximity of the stylus.

5. The device according to claim 1 comprising a key lock enablement indicator, wherein said key lock activator is adapted to examine status of the key lock enablement indicator before setting the key lock into said active state to check whether the key lock can be activated or not.

6. The device according to claim 1, wherein said key lock activator is adapted to set the key lock into said inactive state when the detector does not provide indication of the proximity of the stylus.

7. The device according to claim 6 comprising a delay parameter indicative of a time value, wherein said key lock activator is adapted to set the key lock into said inactive state when the detector has not provided indication of the proximity of the stylus during the time indicated by the delay parameter.

8. The device according to 1 wherein the proximity of the stylus is detected in a predefined area of the touch screen.

9. The device according to 8 wherein an application running in the device determines the area which activates the key lock, in the touch screen.

10. The device according to 8 wherein the user defines the area, which activates the key lock, in the touch screen.

11. The device according to 8 wherein the operating system of the device defines the area, which activates the key lock, in the touch screen.

12. A system comprising at least
a touch screen;
a keypad for providing input functions, the keypad being provided with a key lock operation comprising an active state and a inactive state, the active state being adapted to disable at least part of the input functions of the keypad, and the inactive state being adapted to enable the input functions of the keypad;
a detector for detecting when a stylus is in proximity with the touch screen; and
a key lock activator for setting the key lock into said active state when the detector provides indication of the proximity of the stylus.

13. The system according to claim 12, the touch screen comprising a touch panel, a touch panel controller, and a display; the touch panel controller being adapted to operate as said detector and to provide said indication when the stylus is in proximity with the touch panel.

14. The system according to claim 13, the touch panel controller being adapted to provide said indication when the stylus touches the touch panel.

15. The system according to claim 14, said touch panel controller being adapted to provide indication of coordinate information of the touching point of the stylus on the touch panel, wherein said key lock activator is adapted to use the provided coordinate information as said indication of the proximity of the stylus.

16. The system according to claim 12 comprising a key lock enablement indicator, wherein said key lock activator is adapted to examine the status of the key lock enablement indicator before setting the key lock into said active state to check whether the key lock can be activated or not.

17. The system according to claim 12, wherein said key lock activator is adapted to set the key lock into said inactive state when the detector does not provide indication of the proximity of the stylus.

18. The system according to claim 17 comprising a delay parameter indicative of a time value, wherein said key lock activator is adapted to set the key lock into said inactive state when the detector has not provided indication of the proximity of the stylus during the time indicated by the delay parameter.

19. The system according to 12 wherein the proximity of the stylus is detected in a predefined area of the touch screen.

20. The system according to 19 wherein an application running in the system determines the area which activates the key lock, in the touch screen.

21. The system according to 19 wherein the user defines the area, which activates the key lock, in the touch screen.

22. The system according to 19 wherein the operating system of the system defines the area, which activates the key lock, in the touch screen.

23. A method comprising at least
activating a key lock of a keypad, the keypad being provided with a key lock operation comprising an active state and a inactive state, in which active state at least part of input functions of the keypad being disabled, and in which inactive state the input functions of the keypad being enabled;
detecting when a stylus is in proximity with the touch screen; and
setting the key lock into said active state when the proximity of the stylus is detected.

24. The method according to claim 23 comprising providing said indication when the stylus touches the touch panel.

25. The method according to claim 23 comprising providing indication of coordinate information of the touching point of the stylus on the touch panel, wherein the provided coordinate information is used as said indication of the proximity of the stylus.

26. The method according to claim 23 comprising enabling or disabling the key lock, wherein the method comprises examining if the key lock is enabled before setting the key lock into said active state to determine whether the key lock can be activated or not.

27. The method according to claim 23 comprising setting the key lock into said inactive state when no indication of the proximity of the stylus is provided.

28. The method according to claim 27 comprising setting the key lock into said inactive state when no indication of the proximity of the stylus is provided during a defined time.

29. The method according to 23 comprising detecting the proximity of the stylus in a predefined area of the touch screen.

30. The method according to 29 comprising running an application which determines the area which activates the key lock, in the touch screen.

31. The method according to 29 comprising defining by a user the area, which activates the key lock, in the touch screen.

32. The method according to 29 comprising running an operating system which defines the area, which activates the key lock, in the touch screen.

33. A computer program product comprising machine executable steps for
activating a key lock of a keypad, the keypad being provided with a key lock operation comprising an active state and a inactive state, in which active state at least part of input functions of the keypad being disabled, and in which inactive state the input functions of the keypad being enabled;
detecting when a stylus is in proximity with the touch screen; and
setting the key lock into said active state when the proximity of the stylus is detected.

34. The computer program product according to 33 comprising machine executable steps for defining an area of the touch screen in which the proximity of the stylus can be detected.

35. The computer program product according to 34 wherein an application running in the device is adapted to determine the area, in which the key lock can be activated in the touch screen.

36. The computer program product according to 34 comprising machine executable steps for enabling a user to define an area of the touch screen in which the key lock can be activated in the touch screen.

37. The computer program product according to 34 wherein the operating system is adapted to define the area, which can be used to activate the key lock, in the touch screen.
